(19) United States
(12) Patent Application Publication
(10) Pub. No.: US 2007/0143175 A1
(43) Pub. Date: Jun. 21, 2007

(54) Centralized model for coordinating update of multiple reports

(75) Inventors: Ian Tien, Seattle, WA (US); Chen-I Lim, Bellevue, WA (US); Corey Hulen, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/313,899

(22) Filed: Dec. 21, 2005

(51) Int. Cl. G06F 11/34

(52) U.S. Cl. 705/11

(57) ABSTRACT

Updates to multiple reports are centrally managed in a business logic system. A scorecard application provides a scorecard presentation and determines a report parameter associated with the presentation based on user selection, user credentials, and the like. Data that includes content and/or metadata associated with the report parameter is provided to a target application through a framework manager. Scorecard calculations and presentation may also be updated based on data received from the target application.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Scorecards are used to provide detailed and summary analysis of KPI's and aggregated KPI's such as KPI groups, objectives, and the like. Scorecard calculation results may be presented to various subscribers based on their preference, data source, analysis choices, and the like. Business users may desire to see the details behind their critical business metrics when viewing scorecards. Typically, this may be done by clicking on links and bringing up individual reports in multiple applications. If the context of the initial query changes, the user may have to reopen all applications again. Thus, managing applications that consume scorecard information individually is a burdensome task.

### SUMMARY

A centralized approach is used for managing updates to multiple reports in a business logic system. A report parameter associated with a scorecard presentation, such as a scorecard identifier, a scorecard view identifier, a row group identifier, a column group identifier, a page filter, a KPI group identifier, an objective identifier, or a KPI identifier, is determined by a scorecard application. Data that includes content and/or metadata associated with the report parameter is provided to a target application directly or through a framework manager for consumption by the target application.

Scorecard calculations and presentation may also be updated based on data received from the target application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a business logic application centrally managing scorecard-based reports may be executed;

FIG. 2 illustrates a system, where example embodiments of centrally managing multiple scorecard-based reports may be implemented;

FIG. 3 illustrates an example scorecard architecture according to embodiments;

FIG. 4 illustrates a screenshot of an example scorecard;

FIG. 5 illustrates a conceptual diagram of a scorecard presentation with zones for applications that consume scorecard information;

FIG. 6 illustrates a screenshot of an example scorecard presentation with two associated zones;

FIG. 7 illustrates a screenshot of the example scorecard presentation of FIG. 6 with three associated zones;

FIG. 8 illustrates a screenshot of a user interface for editing page filter parameters;

FIG. 9 illustrates a table listing report parameters that are passed by a scorecard application to target applications; and

FIG. 10 illustrates a logic flow diagram of a process for centrally managing updates to multiple reports in a business logic system.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

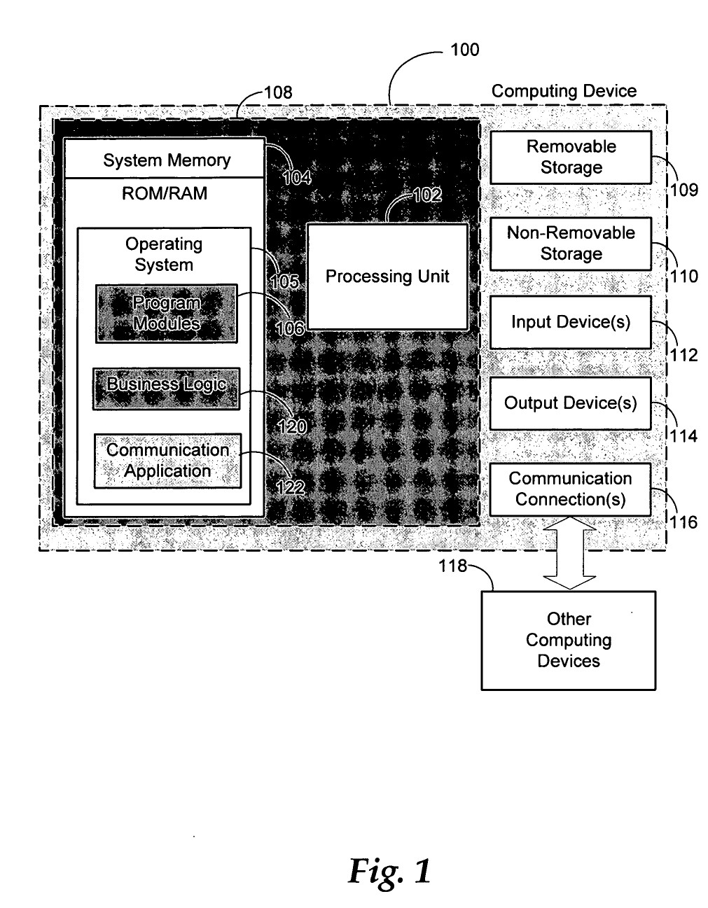

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105 and one or more program modules 106 working within operating system 105.

In addition to program modules 106, business logic application 120 may also be executed within operating system 105. Business logic application 120 may include a scorecard application or any similar application to manage business evaluation methods. Business logic application 120 may interact with communication application 122 to centrally manage updates to multiple reports such as scorecard-based report updates between multiple applications performing actions associated with the scorecard calculation.

To perform the actions described above, business logic application 120 and communication application 122 may include and/or interact with other computing devices, applications, and application interfaces (APIs) residing in other applications.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

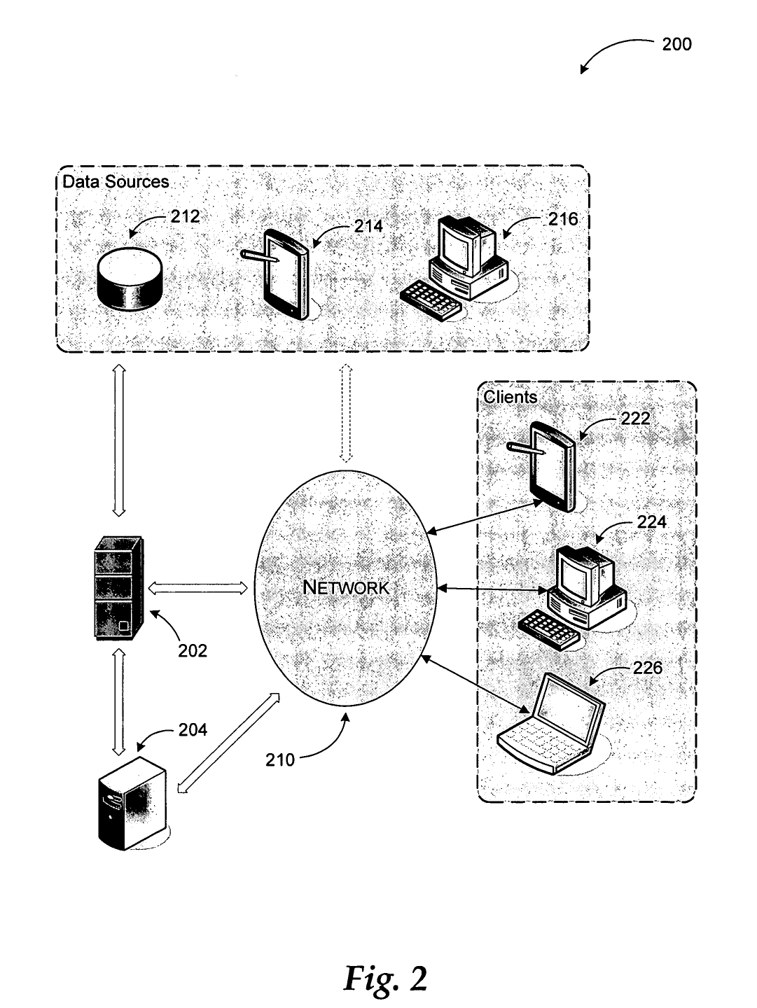

FIG. 2 illustrates system 200, where example embodiments of centrally managing multiple scorecard-based reports may be implemented. System 200 may comprise any topology of servers, clients, Internet service providers, and communication media. Also, system 200 may have a static or dynamic topology.

A business logic application may be run centrally on server 202 or in a distributed manner over several servers (e.g. servers 202 and 204 ) and/or client devices. Server 202 may include implementation of a number of information systems such as performance measures, business scorecards, and exception reporting. A number of organization-specific applications including, but not limited to, financial reporting, analysis, booking, marketing analysis, customer service, and manufacturing planning applications may also be configured, deployed, and shared in system 200. In addition, the business logic application may also be run in one or more client devices and information exchanged over network 210.

Data sources 212, 214, and 216 are examples of a number of data sources that may provide input to server 202. Additional data sources may include SQL servers, databases, non multi-dimensional data sources such as text files or EXCEL(® sheets, multi-dimensional data source such as data cubes, and the like.

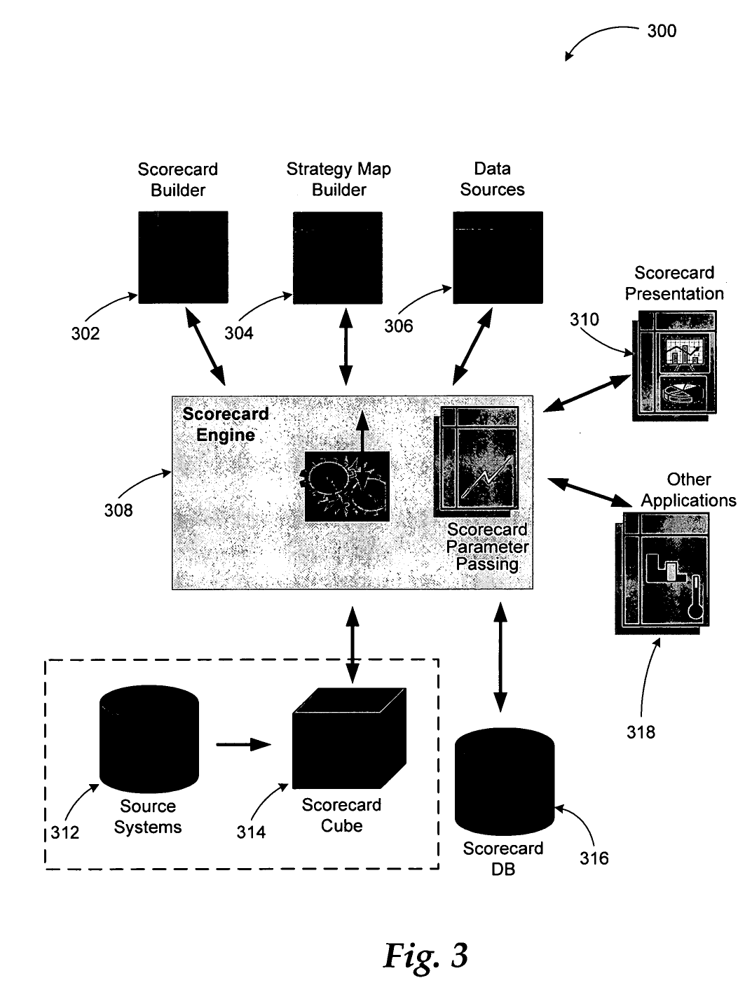

Users may interact with server 202 running the business logic application from client devices 222, 224, and 226 over network 210. In one embodiment, additional applications that consume scorecard-based data may reside on server 202 or client devices 222, 224, and 226. Examples of such applications and their relation to the scorecard application are provided below in conjunction with FIG. 3.

Network 210 may be a secure network such as an enterprise network, or an unsecure network such as a wireless open network. Network 210 provides communication between the nodes described above. By way of example, and not limitation, network 210 may include wired media such as a wired network or direct-wired connection, and wireless media such as acoustic, RF, infrared and other wireless media.

Many other configurations of computing devices, applications, data sources, data distribution and analysis systems may be employed to implement a business logic application centrally managing updates to scorecard-based reports.

FIG. 3 illustrates example scorecard architecture 300. Scorecard architecture 300 may comprise any topology of processing systems, storage systems, source systems, and configuration systems. Scorecard architecture 300 may also have a static or dynamic topology.

Scorecards are a simple method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application that is arranged to evaluate performance metrics. Scorecard engine 308 may be loaded into a server, executed over a distributed network, executed in a client device, and the like.

In addition to performing scorecard calculation, scorecard engine may also provide report parameters associated with a scorecard to other applications 318. The report parameters may be determined based on a subscriber request or a user interface configuration. The user interface configuration may include a subscriber credential or a subscriber permission attribute. The report parameter may include a scorecard identifier, a scorecard view identifier, a row identifier, a column identifier, a page filter, a performance measure group identifier, or a performance measure identifier. The performance measure may be a KPI, a KPI group, or an objective. The page filter determines a period and an organizational unit for application of the scorecard calculations.

Data for evaluating various measures may be provided by a data source. The data source may include source systems 312, which provide data to a scorecard cube 314. Source systems 312 may include multi-dimensional databases such as an Online Analytical Processing (OLAP) database, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a Graphical User Interface (GUI), and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other Open Database Connectivity (ODBC)—accessible data source systems (e.g. Excel, text files, etc.). Data sources 306 may also define KPI mappings and other associated data.

Scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like. A user interface for scorecard presentation 310 may also include an overview of available scorecards for a subscriber to select from.

Scorecard presentation 310 may further include a matrix or a list presentation of the scorecard data. The scorecard presentation and one or more zones for other applications may be displayed in an integrated manner.

Other applications 318 may include any application that receives data associated with a report parameter and consumes the data to provide a report, perform analysis, provide alerts, perform further calculations, and the like. The data associated with the report parameter includes content data and metadata. Other applications may be selected based on the report parameter, a subscriber request, or a user interface configuration. The user interface configuration may include a subscriber credential or a subscriber permission attribute. Other applications 318 may include a graphical representation application, a database application, a data analysis application, a communications application, an alerting application, or a word processing application.

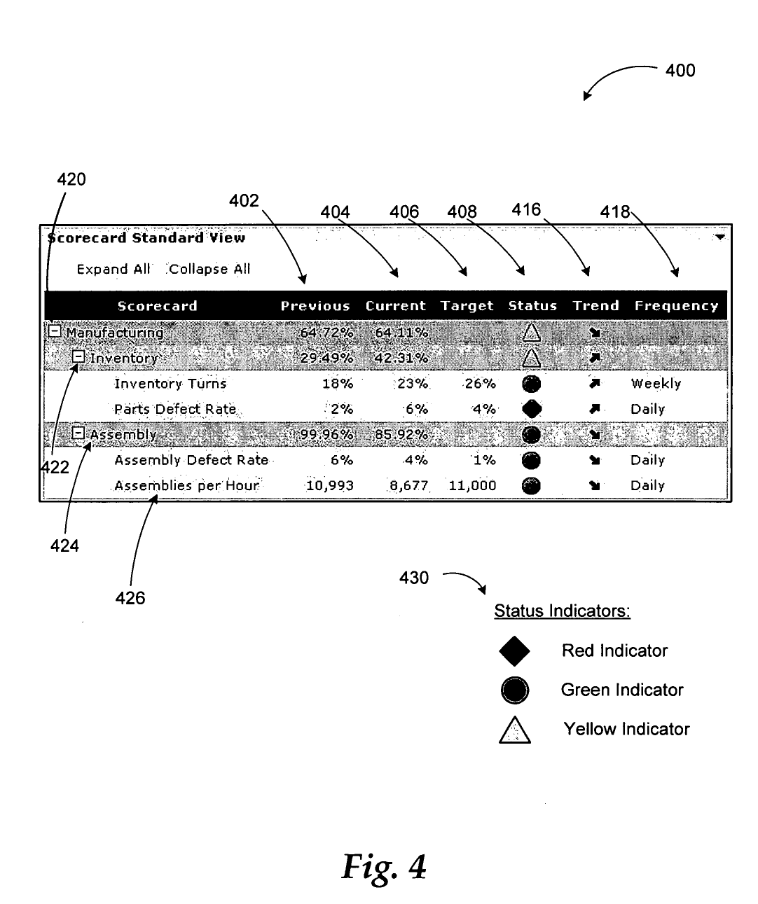

FIG. 4 illustrates a screenshot of an example scorecard. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. The shared use of KPI definition may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes. The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The trend arrows displayed in scorecard 400 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400 shows example elements perspective 420 “Manufacturing” with objectives 422 and 424 “Inventory” and “Assembly” (respectively) reporting to it. Second column 402 in scorecard 400 shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400. Target values may be retrieved from a database, entered by a user, and the like. Column 408 of scorecard 400 shows status indicators.

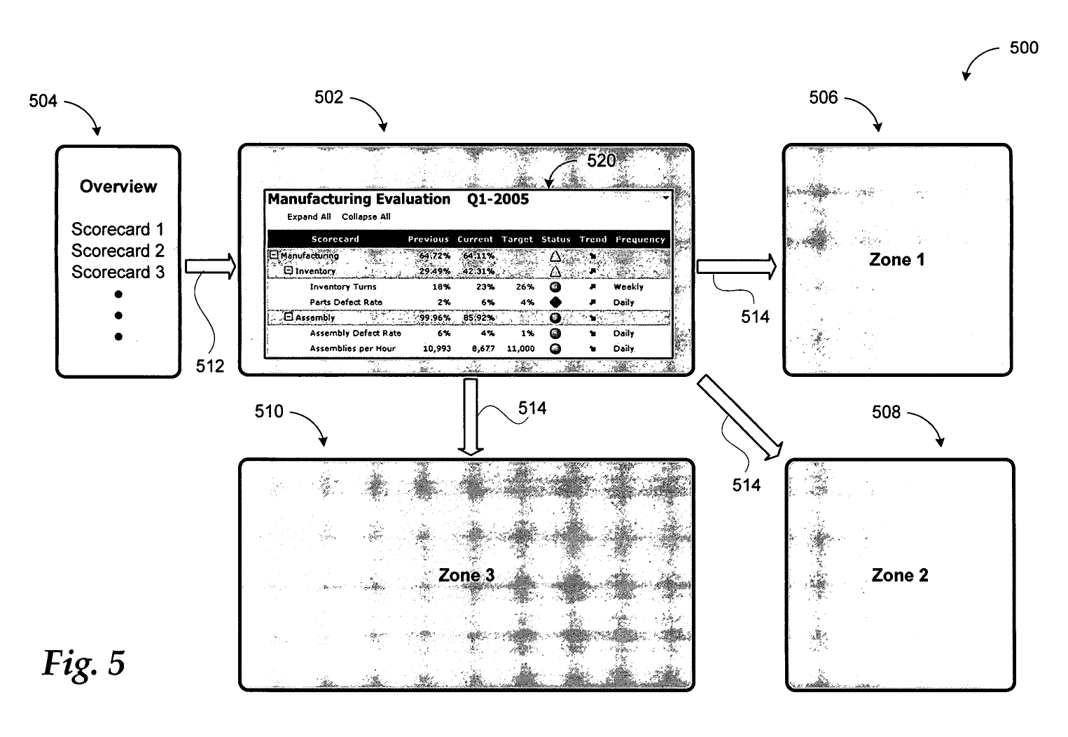

Status indicators 430 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands as described below in conjunction with FIG. 5.

Column 416 includes trend type arrows as explained above under KPI attributes. Column 418 shows another KPI attribute, frequency.

FIG. 5 illustrates conceptual diagram 500 of a scorecard presentation with zones for applications that consume scorecard information. Diagram 600 includes scorecard view 502 with scorecard 520, overview 504 and zones 1 through 3 (506, 508, 510).

Scorecard view 502 is the scorecard presentation screen of a scorecard application. It presents example scorecard 520 for “Manufacturing Evaluation” for first quarter of 2005 (Q1-2005). Elements of scorecard 520 such as KPI's, objectives, columns, indicators, and the like have been described previously.

Overview 504 is another user interface (UI) of the scorecard application that presents a subscriber available scorecards for selection. In some embodiments, scorecard 520 may be selected dynamically based on subscriber credentials, UI configuration, and the like. Interaction 512 illustrates data flow from overview 504 to scorecard view 502 associated with the scorecard selection.

According to some embodiments, the scorecard application may include one or more zones for displaying user interfaces of other applications associated with the scorecard application. Such applications may include a graphical representation application, a database application, a data analysis application, a communications application, an alerting application, and a word processing application. These applications may receive data associated with the scorecard and present various UI's to the user such as an interactive chart, an alert UI, a communication forum for subscribers, and the like. A layout of the zones may be determined by a default configuration of the scorecard application, user selection, and the like.

According to one embodiment, page filters, row slices, column slices, and the like may be sent from a scorecard view through a query string to another application. This enables a subscriber to create a custom view that displays selected data in an active cell in a scorecard view. The information may be passed to the other application in form of a query string.

When the subscriber selects data in a scorecard that has page filters, a query string is generated. The items in the query string may be in form of well-formed XML fragments. Each XML fragment may contain a root node for page filters, row slices, and column slices. The root node might or might not contain child nodes, depending on what page filters, row slices, or column slices are passed. Other information that is passed in the query string may include the scorecard ID, the objective ID, and the KPI measure ID.

Data associated with the scorecard (e.g. query strings in form of XML fragments) may be provided to the other applications in zones 506, 508, and 510 through data flows 514. While data flows 514 are shown unidirectional, bidirectional data flow may also be implemented. According to another embodiment, data associated with the scorecard may be provided by a target application to the scorecard application for updating the scorecard.

Blocks and illustrations of diagram 500 are exemplary, and do not constitute a limitation on embodiments. Other embodiments may be implemented using different number of zones, different layouts, and scorecard views.

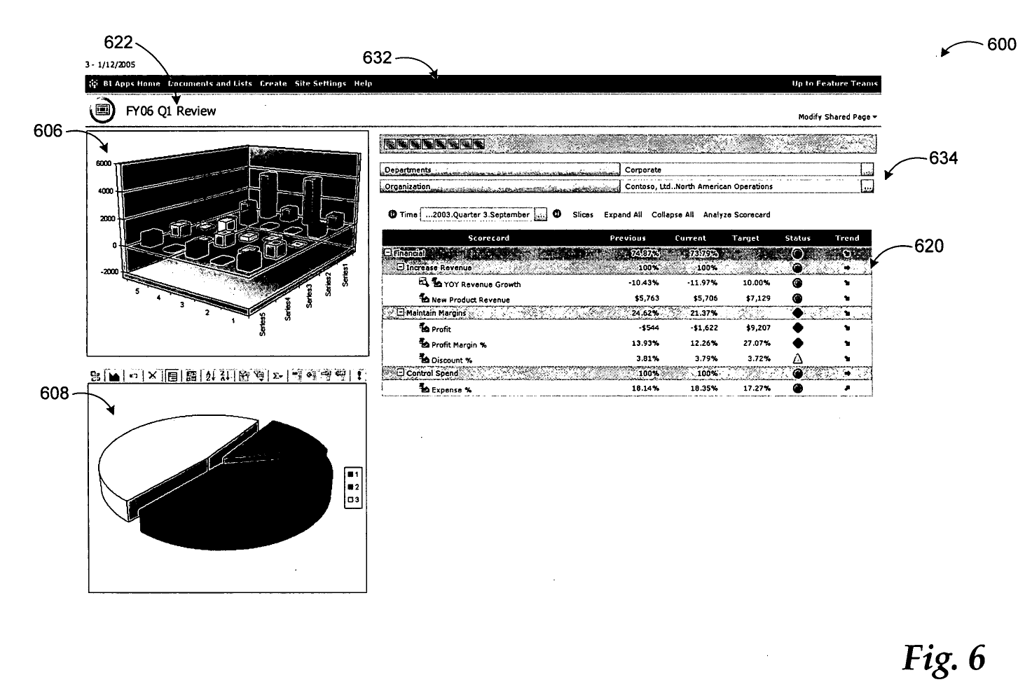

FIG. 6 illustrates a screenshot of example scorecard presentation 600 with two associated zones. Diagram 600 includes menu bar 632, scorecard indicator 622, scorecard 620, page filter UI 634, and associated application UI's 606 and 608.

Scorecard indicator 622 summarizes a description of the scorecard and provides the time period for the scorecard such as FY06 Q1 Review. Scorecard 620 includes different levels of KPI's and objectives along with associated actuals, targets, and status indicators. Page filter UI 634 provides drop-down menu style selection for organizational units and time periods to be selected for the presented scorecard. By selecting among the available time periods and organizational units, a subscriber changes source data for the scorecard.

Associated application UI's 606 and 608 show two different charts based on scorecard 620. The data for the presented charts may be passed by the scorecard application to the charting application such as Microsoft Excel®. Other applications such as those listed before may also be presented in associated application UI's 606 and 608. Furthermore, a layout of the application UI's may be set in different manners.

While charting applications are shown with limited UI elements, other applications may include UI elements that enable a subscriber to submit modifications to the report parameters (scorecard elements that are passed to the applications). In that case, the submitted modifications may be received by the scorecard application and scorecard 620 updated based on the modifications.

Other scorecard presentations, target applications, status indicators, and the like may be implemented using the principles described herein.

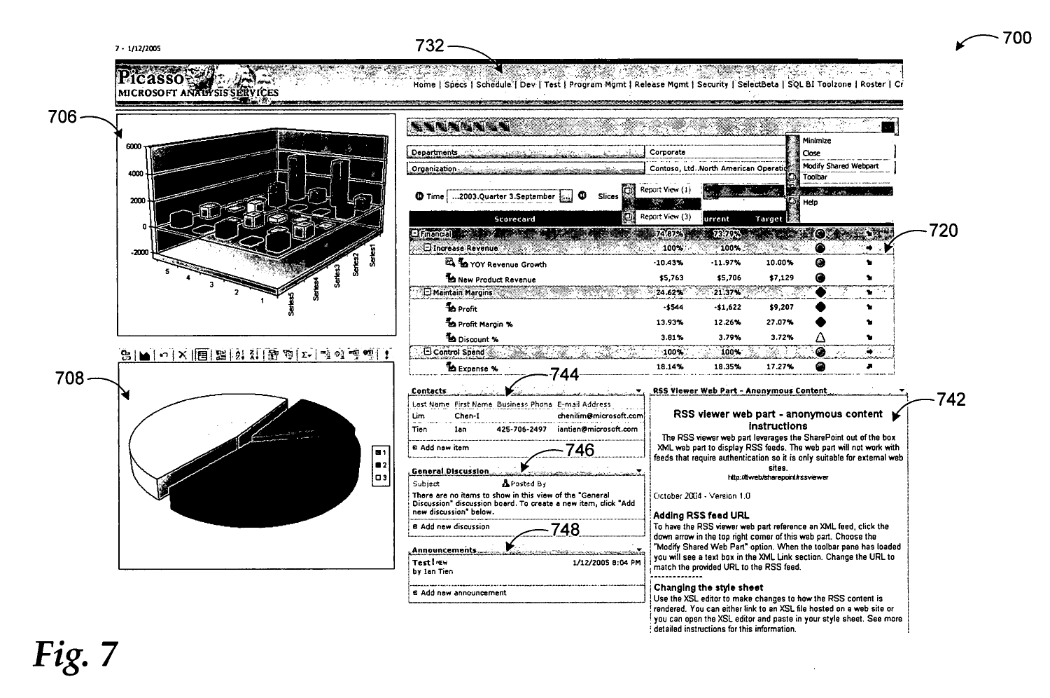

FIG. 7 illustrates a screenshot of the example scorecard presentation of FIG. 6 with three associated zones. Diagram 700 includes menu bar 732, scorecard 720, and associated application UI's 706 and 708 that are the same as in FIG. 6. In addition, RSS (Resource Description Framework Site Summary) Viewer application 742 and associated communication application UI's 744-748 are also shown.

RSS Viewer application 742 may be used to display RSS feeds associated with the scorecard application and the presented scorecard. Communication application UI's 744-748 include Contacts 742, which lists names and contact information for subscribers associated with the presented scorecard; General Discussion forum 746, which may be used to facilitate a discussion among subscribers; and Announcements 748, which may be used to provide information such as alerts to subscribers related to the presented scorecard.

For example, alerts with different conditions may be assigned to the scores specific to individual levels or aggregate levels (e.g. objectives). Alerts may be based on absolute value comparisons (e.g. actual to target, actual to a threshold, and the like), status indicators (e.g. traffic light scheme, banding, trend scheme), range comparisons (e.g. actual or actual to target ratio within a range, outside a range, and the like), or on/off target determinations.

Alerts may also be based on transitions of scores in one direction or in any direction (e.g. when status changes from green to yellow or when actual changes from on-target in any direction). Additionally, alerts may also be determined based on a predetermined combination of conditions or other alerts. The alerts may be provided to subscribers on Announcements 748 or through a more directed application such as an email application, a text message application, and the like.

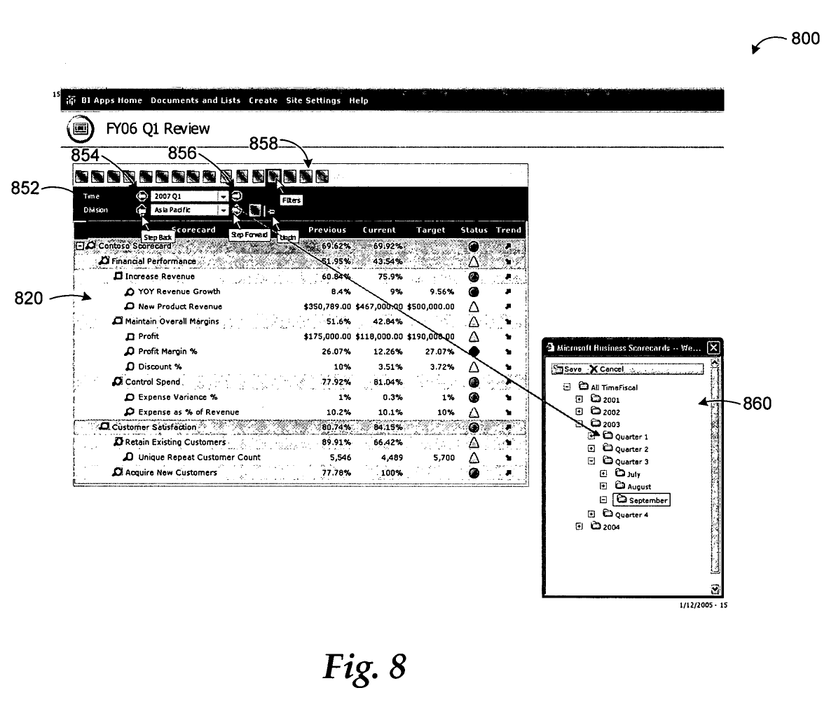

FIG. 8 illustrates a screenshot of user interface 800 for editing page filter parameters. Page filtering is used to apply the parameters of a particular scorecard to a different set of data. For example, the same scorecard may be recalculated and presented for different time periods (e.g. quarters of selected fiscal years) or for different organizational units (e.g. sales figures for Washington, California, Florida, etc.).

UI 800 includes summary indicator for the current scorecard (FY06Q1 Review), time and organizational unit selectors 852, filter buttons 858, scorecard 820, and available time periods window 860.

Page filter element define (partially) a scorecard view. Therefore, passing the page filter associated data to a target application provides not only data associated with the current scorecard, but also metadata associated with the scorecard view.

Selection of time periods and organizational units may be performed in many ways. UI 800 illustrates some example methods of prompting a subscriber to select among available choices. Desired time period or organizational unit may be entered in a text box. They may be selected from a drop-down menu, incremented using stepper buttons 854 and 856, or selected from a pop-up style window that lists available choices in a directory-tree format (e.g. window 860 ).

Other selection methods may also be implemented using the principles described herein. Moreover, other elements of the scorecard, such as row slices, column slices, and the like, may also be selected using one of the methods described above.

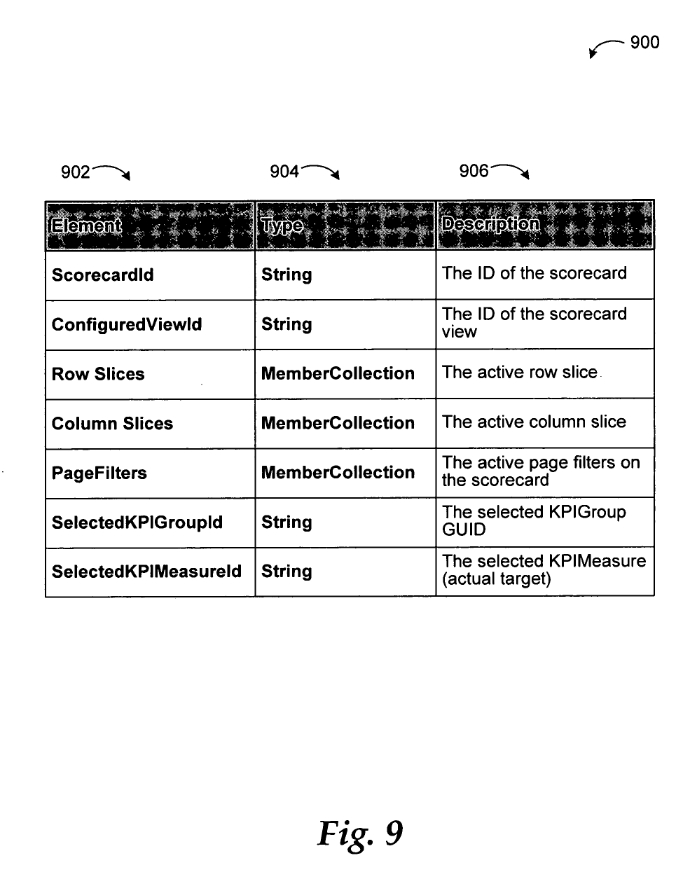

FIG. 9 illustrates table 900 listing report parameters that are passed by a scorecard application to target applications. The report parameters are scorecard elements.

Elements of scorecard may include a scorecard ID, a configuration ID of the scorecard, selected rows (row slices), selected columns (column slices), page filters, selected KPI measures (actual and/or target values), and selected KPI groups. These are listed in column 902 of table 900. Column 904 lists variable types for each of the elements. Finally, column 906 lists descriptions of the elements in scorecard terminology.

The scorecard elements that may be passed to target applications are not limited to those listed above. Others such as status indicators, frequency indicators, and the like may also be passed by the scorecard application.

As described previously, scorecard elements may be passed to target applications in form of query strings in an XML file. Below is an example code listing several elements to be passed by a scorecard application:

```
<ConnectionViewData>
  <ScorecardId>b992d8e0-2262-4a33-8c81-
494cd4e06352</ScorecardId>
  <ConfiguredViewId>5f597ac4-f28c-4667-aa26-
52991d77eb51</ConfiguredViewId>
  <PageFilters>
    <Member DisplayName=“CA” UniqueName=“[Customers].[All
Customers].[USA].[CA]” LevelName=“[Customers].[State Province]”
LevelDepth=“2” ChildCount=“45” IsAllLevel=“false” />
    <Member DisplayName=“Supermarket” UniqueName=“[Store
Type].[All Store Type].[Supermarket]” LevelName=“[Store
Type].[Store Type]” LevelDepth=“1” ChildCount=“0”
IsAllLevel=“false” />
  </PageFilters>
  <SelectedKpiGroupId>1cb6126d-483f-45e4-8164-31e66992b26f
  </SelectedKpiGroupId>
  <SelectedKpiMeasureId>97123012-f1af-32e4-8131-
87123992b213</SelectedKpiMeasureId>
</ConnectionViewData>
```

The example code passes a scorecard ID, a configuration view ID, page filters specifying organization and hierarchy levels, a selected KPI measure, and a selected KPI group ID.

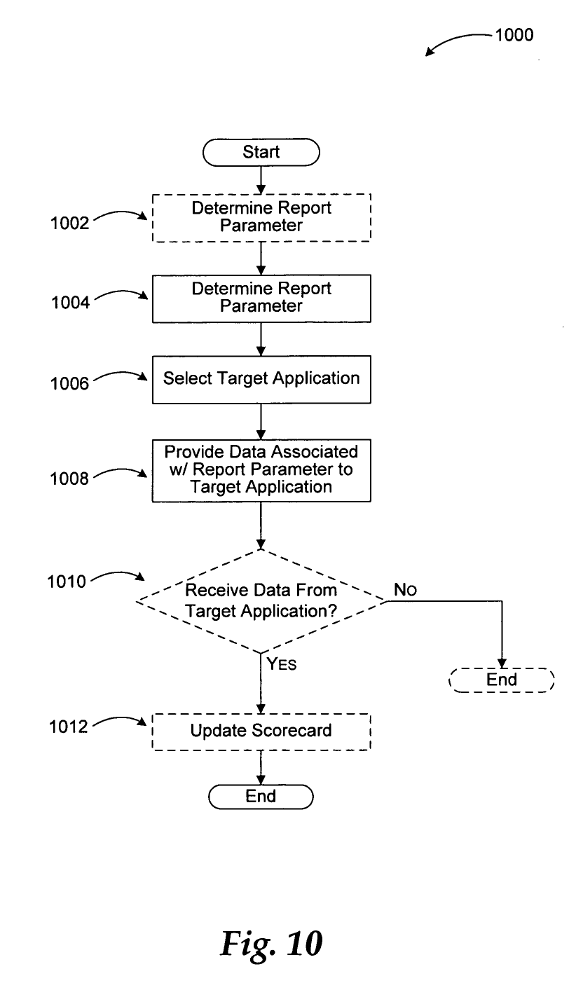

FIG. 10 illustrates a logic flow diagram of process 1000 for centrally managing updates to multiple reports in a business logic system.

According to some embodiments, a method for centralized management of updates to multiple reports includes determining a report parameter of a scorecard presentation, selecting a target application for providing data associated with the report parameter, and providing the data to the target application. The method may further include selecting the scorecard presentation based on a list of available scorecards. The data may be provided to the target application directly or via a framework manager in form of a query string in an eXtensible Mark-up Language (XML) file. The method may also include receiving update information associated with the report parameter from the target application and using the update information to recalculate the scorecard. The method may be implemented in form of instructions stored on a computer-readable medium or executed in a system that includes a scorecard engine.

Process 1000 begins at optional operation 1002, where a scorecard is selected from a list of available scorecards. In a scorecard application, the user interface may include an overview pane that provides a list of available scorecards in any graphical or text form. A subscriber may then be prompted to select among the scorecards. In other embodiments, the selection may be done automatically based on subscriber credentials, scorecard application UI configuration, and the like. Processing advances from optional operation 1002 to operation 1004.

At operation 1004, a report parameter is determined. The report parameter may include a scorecard identifier, a scorecard view identifier, a row identifier, a column identifier, a page filter, a performance measure group identifier, or a performance measure identifier. The performance measure may include a low level KPI, a higher level KPI to which other KPI's report, or an objective. The report parameter may be determined based on a subscriber selection, subscriber credentials such as permissions assigned to the subscriber, or a scorecard configuration. Processing moves from operation 1004 to operation 1006.

At operation 1006, a target application is selected. The target application may be selected based on a UI configuration, subscriber selection, and the like. The target application(s) may reside on the same machine as the scorecard application or they may be distributed over a network. The target application may even be a module of the scorecard application. Processing proceeds from operation 1006 to operation 1008.

At operation 1008, data associated with the report parameter is provided to the selected target application for consumption. The data associated with the report parameter may include content as well as metadata. For example, the target application may be a charting application, and the data may include selected KPI's and columns of the scorecard. The data in this case may include the content such as actual and target values for the selected KPI's along with type of content (string, number, character, e.g.). Processing moves from operation 1008 to optional decision operation 1010.

At optional decision operation 1010, a determination is made whether data associated with the report parameter(s) is received from a target application. As mentioned above, the exchange of data associated with the report parameter(s) may be bidirectional. While the scorecard application centrally manages updating of reports to a number of target applications, it may also receive data back from the target applications. In such cases, the scorecard application may update the scorecard and subsequent reports based on the received data. If the determination at optional decision operation is affirmative, processing moves to optional operation 1012. Otherwise, processing terminates.

At optional operation 1012, the scorecard and the scorecard presentation is updated based on the data received from one or more target applications. Subsequent reports may also be updated responsive to the changes. After optional operation 1012, processing moves to a calling process for further actions.

The operations included in process 1000 are for illustration purposes. Centrally managing updates to multiple reports in a business logic may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for centralized management of updates to multiple reports, comprising:
determining a report parameter of a scorecard presentation;
selecting a target application for providing data associated with the report parameter, wherein the target application is arranged to consume the data for performing actions associated with the scorecard presentation; and
providing the data to the target application.

2. The computer-implemented method of claim 1, wherein the target application is selected based on at least one of: the report parameter, a subscriber request, and a user interface configuration.

3. The computer-implemented method of claim 2, wherein the user interface configuration includes at least one of a subscriber credential and a subscriber permission attribute.

4. The computer-implemented method of claim 1, further comprising selecting the scorecard presentation based on a list of available scorecards.

5. The computer-implemented method of claim 1, further comprising providing the data to the target application via a framework manager.

6. The computer-implemented method of claim 1, wherein the report parameter includes at least one of a scorecard identifier, a scorecard view identifier, a row identifier, a column identifier, a page filter, a performance measure group identifier, and a performance measure identifier.

7. The computer-implemented method of claim 6, wherein the performance measure is one of a Key Performance Indicator (KPI) and an objective.

8. The computer-implemented method of claim 1, wherein the scorecard presentation is one of a matrix and a list.

9. The computer-implemented method of claim 1, further comprising receiving update information associated with the report parameter from the target application and using the update information to recalculate the scorecard.

10. The computer-implemented method of claim 1, wherein the report parameter includes a page filter that is arranged to determine a temporal and an organizational source of scorecard calculation data.

11. The computer-implemented method of claim 1, wherein the data is provided to the target application in form of a query string in an extensible Mark-up Language (XML) file.

12. A computer-readable medium having computer instructions for managing central update of scorecard-based reports in a business logic system, the instructions comprising:
selecting a scorecard presentation based on a list of available scorecards;
determining a report parameter of the scorecard presentation;
selecting a target application for providing data associated with the report parameter; and
providing the data to the target application.

13. The computer-readable medium of claim 12, wherein the report parameter includes at least one of a scorecard identifier, a scorecard view identifier, a row group identifier, a column group identifier, a page filter, a KPI group identifier, an objective identifier, and a KPI identifier.

14. The computer-readable medium of claim 13, wherein the page filter determines a period and an organizational unit for application of the scorecard calculations.

15. The computer-readable medium of claim 12, further comprising receiving additional data associated with the report parameter from the target application and using the additional data to update the report parameter.

16. The computer-readable medium of claim 12, wherein the data associated with the report parameter includes content data and metadata.

17. A system for providing centrally managing updates to scorecard-based reports, the system comprising:
a score-calculation engine configured to:
determine a report parameter of a scorecard presentation;
select a target application for providing data associated with the report parameter; and
provide the data to the target application; and
a user interface configured to:
display the scorecard presentation; and
provide at least one zone for subscriber interaction with the target application.

18. The system of claim 17, wherein the user interface further includes an overview of available scorecards for a subscriber to select from.

19. The system of claim 17, wherein the scorecard. presentation and the at least one zone are displayed in an integrated manner.

20. The system of claim 17, wherein the target application includes at least one of: a graphical representation application, a database application, a data analysis application, a communications application, an alerting application, and a word processing application.
